(19) United States
(12) Patent Application Publication
(10) Pub. No.: US 2009/0006136 A1
(43) Pub. Date: Jan. 1, 2009

(54) System and method for insuring against property inspection contingencies

(76) Inventor: Anita Shapiro, Holland, PA (US)

Correspondence Address: Howard IP Law Group, P.O. Box 226, Fort Washington, PA, 19034, US

(21) Appl. No.: 11/823,354

(22) Filed: Jun. 27, 2007

(51) Int. Cl. G06Q 40/00

(52) U.S. Cl. 705/4

(57) ABSTRACT

The invention herein provides indemnity insurance that insures against the risk that a property inspection will reveal a defect that cannot be rehabilitated, causing a contract contingent on a satisfactory property condition to result in the termination of a contract for the sale of the property. More particularly the invention includes identifying a property for sale having an associated risk of a defect; recording a contract for sale having an inspection contingency; generating an insurance policy that accounts for the risk of not satisfying the contingency. The invention further includes generating actuarial statistics from a population of contracts having been voided for failing to meet an inspection contingency; underwriting and binding an insurance policy indemnifying one of a prospective buyer or a seller according to an insurable interest in the property for sale and the actuarial statistics.

### FIELD OF THE INVENTION

This invention relates to a method and system for underwriting, issuing and managing an insurance policy to indemnify against losses associated with property inspections.

### BACKGROUND OF THE INVENTION

A seller and a prospective buyer of properties, whether personal property or real estate, often enter into a written contract that specifies the conditions under which the property ownership will transfer or close. A satisfactory inspection result as determined by an inspection performed by the buyer's agent is a usual condition of closing. In some instances a property defect can be remediated. If the buyer and seller do not reach an agreement as to remediation during a time specified by the parties the buyer may terminate the sales contract. In the event that the buyer does not terminate the sales contract within that time, the buyer will normally accept the property and agree to release the seller from further obligations related to the condition of the property.

Pre-sale property inspections are prevalent in real estate transactions and the price of a property reflects a number of factors such as type or structure, location, best use, age and quality among other things. Workmanship, materials and its current status or condition determine the quality of real estate. Buyers and sellers usually agree that as a condition of sale that the buyer's agents, typically professional contractors, home inspectors, engineers, architects and other properly licensed or otherwise qualified professionals perform a property inspection, certification and/or investigation. The items that are inspected may for example include: structural; roof; exterior windows and exterior doors; exterior siding, fascia, gutters and downspouts; swimming pools, hot tubs and spas; appliances; electrical, plumbing, heating and cooling systems; water penetration; environmental hazards (e.g., mold, fungi, indoor air quality, radiation; asbestos, underground storage tanks, etc.); electromagnetic fields; wetlands inspection; flood plain verification; property square footage verification; and nearly any other items the buyer may select. Within the time fixed for such an inspection, referred to as in some instances a contingency period, a buyer, typically at its expense, may have some or all the inspections, certifications and/or investigations as indicated above completed by qualified professionals.

From the inspector's appraisal the buyer can make an informed decision regarding price and points it may negotiate regarding remediation prior to purchase. Therefore, a buyer of a home or a commercial property needs to learn as much as possible, particularly the need for any repairs prior to closing on a property. Frequently, the inspection reveals defects in a property that in the buyer's opinion need remediation. However, according to real estate conventions buyers generally offer to purchase real estate based upon a contract provision conditioned upon a satisfactory inspection or at least satisfactory resolution of issues surrounding an inspection. When the parties do not resolve the inspection issues the buyer must accept the terms put forth by the seller or void the contract based upon the inspection contingency not having been met. Therefore, an inspection is an integral part of the purchase transaction.

The inspection contingencies elected by a buyer are often controlled by certain options and time periods or contingency periods. By way of example and not limitation one option allows a buyer to choose to accept a property for sale with the information as stated in an inspection report and to release the seller from any further obligations. The buyer may also choose, if not satisfied with the information stated in the report, to terminate the transaction, typically by voiding the sales contract and having all deposits returned. Yet another option is for the buyer and seller to enter into an agreement where the seller must repair or improve the property. When the seller concedes that certain items in the inspection report need remediation, the seller may offer to settle the matter by cash or credit at the time of the closing, providing such an arrangement is also acceptable to others that may have an interest in the property such as the mortgage lender.

The foregoing process proceeds more formally by way of a proposal offered by a buyer following an inspection. The seller typically responds to the buyer's proposal by choosing to: (1) satisfy the terms of buyer's proposal, or (2) credit buyer at settlement for the costs to satisfy the terms of buyer's proposal, again provided this is acceptable to others that may have an interest in the property such as the mortgage lender. However, a seller may not accept the terms of buyer's proposal and therefore not credit the buyer at settlement for the costs to satisfy the terms of buyer's proposal. If the seller agrees to satisfy the terms of the buyer's proposal or to credit buyer at settlement as specified above, the buyer accepts the property and typically releases the seller from further obligation in connection with the inspection defects. If a buyer offers a settlement, but the seller chooses not to satisfy the terms of buyer's proposal and not to credit buyer at settlement as specified above, or if seller fails to choose any option offered by the buyer within the time given, the buyer may (1) accept the property with the information stated in the report (allegedly reflecting the condition of the property) or (2) terminate the sales contract with all deposit monies returned to buyer or (3) enter into an agreement with seller providing for any repairs or improvements to the property and/or credit to buyer at settlement, providing any of the chosen option is acceptable to others that may have an interest in the property such as the mortgage lender.

Most real estate transactions require the buyer to pay for the inspection, although in some instances the seller may assume the obligation of payment. Costs and loses associated with a contract voided for the condition related to a satisfactory inspection are several. Although the cost of inspection is an unrecovered cost whether or not a party voids the contract for sale on the grounds that the inspection conditions have not been met, the transaction cost increases significantly (i.e. an inspection cost can be considered a small additional cost associated with the purchase if the purchase proceeds). Secondly, there are lost opportunity losses having to do with resuming efforts to find another more suitable property and the cost of the next inspection, which for residential properties can run from the low hundreds to the several thousands of dollars. In commercial real estate the cost of an inspection may run from the low to high thousands of dollars. Additionally, the unrecovered cost factor may bear upon a party's willingness to accept an otherwise unfavorable offer, since buyers consider the potential of having to spend inspection fees multiple times, based for each property it may make an offer to purchase.

### SUMMARY OF THE INVENTION

One embodiment of the present invention is a method for underwriting insurance for an insurable interest in a property for sale comprising the steps of: identifying a property for sale having an associated risk of a defect; entering into a contract for sale having an inspection contingency; and generating an insurance policy that accounts for the risk of not satisfying the contingency. In one embodiment the method includes the steps of generating actuarial statistics from a population of contracts having been voided for failing to meet an inspection contingency; underwriting an insurance policy indemnifying one of a prospective buyer or a seller according to an insurable interest in the property for sale and according to the actuarial statistics; executing by the buyer and the seller a purchase contract for sale of a property; conducting at least one inspection for the insurable interest wherein the inspection reveals the presence of the at least one defect; voiding the contract; and indemnifying the insured party for the cost of the inspection.

In another embodiment of the invention a computer system and a computer readable medium for mitigating risk associated with property inspections wherein the inspection reveals a defect in a property for sale. The computer medium includes code for storing data indicative of a plurality of property sale contracts in at least one database; code for storing data indicative of the plurality of property inspections in at least one database; code for storing data indicative of a plurality of insurance policies; each policy being associated with a corresponding one of the plurality of inspections in at least one database; code for storing data indicative of one of time-frames or events which require notice regarding termination of each of the property sale contracts for failure of the inspection contingency not having been met; code for insuring one of the buyer or seller of the property for sale for costs or loses resulting from a failure to close on the property due to a defect in the property revealed during the inspection.

In yet another embodiment of the invention a data processing system is used to underwrite, generate and manage insurance policies to mitigate the risk of loss due to costs and loses associated with property inspections following inspection of a property for sale. This embodiment includes a CPU for processing data; and one or more databases and/or memories for storing data indicative of an underwriting an insurance policy that indemnifies against losses sustained by one of a buyer or a seller in the event of a defect found in the property for sale following an inspection; and voiding the sale.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is a flow chart illustrating a method for generating an insurance policy according to an embodiment of the invention;

FIG. 2 is a flow chart illustrating a system for generating of an insurance policy according to an embodiment of the invention;

FIG. 3 is a block diagram of a method for generating an insurance policy according to an embodiment of the invention;

FIG. 4 is a flow chart of a method for generating of an insurance policy according to an embodiment of the invention;

FIG. 5 is a flow chart of a method for generating of an insurance policy according to an embodiment of the invention.

### DETAILED DESCRIPTION OF THE INVENTION

In the figures to be discussed the blocks and arrows represent functions of the process according to embodiments of the present invention which may be implemented as computers, computer executable code, and/or electrical circuits and associated wires or data busses, which transport electrical signals. Alternatively, one or more associated arrows may represent communication (e.g., data flow) between functional modules, implemented for example, via software routines, particularly when the present method or apparatus of the present invention.

In the following description contingencies are defined as conditions that must be met if a contract for the sale of property is to be fully executed or performed. Although the embodiments below describe inspections related to real estate, they are applicable and intended to apply to any property wherein the consummation of sale is dependent upon a property inspection. Such properties, by way of example and not limitation, are real estate, aircraft, boats, fine art and intangible properties such as patents. The act of invalidating a contract by a party exercising its rights under the contract when a contingency is not satisfied is usually referred to as voiding the contract. The voiding of a contract amounts to rescinding it. As will be further detailed below generating an insurance policy involves sub processes such as developing risk profiles through actuarial methods, setting the proper premiums commensurate with risk and indemnity obligations, underwriting and contracting with the insured, often referred to as binding a policy. In the context of the invention herein described, the following usages of these terms are as follows: (a) actuarial methods are those employed by an insurance company or agent to calculate premium rates, reserves, dividends and other important figures using risk factors obtained from experience tables; (b) underwriting is the process of evaluating applications for insurance based on an established set of guidelines to determine the risk associated with an applicant and either assigns the appropriate rating class for the policy or declines to offer a policy.

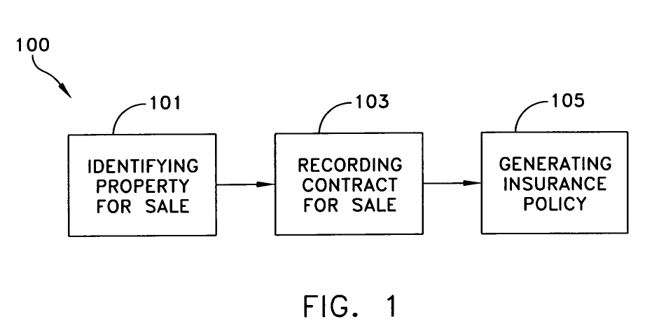

As shown in FIG. 1, an embodiment of the invention is a method 100 for creating an insurance policy that countervails against the financial risk of paying for an inspection on a prospective property purchase that may not close due to a property defect that is unresolved by the parties. The method for creating an insurance policy requires identifying 101 a property for sale having an associated risk of a defect; recording 103 a contract for sale having an inspection contingency; generating 105 an insurance policy that indemnifies against the risk of not satisfying the contingency.

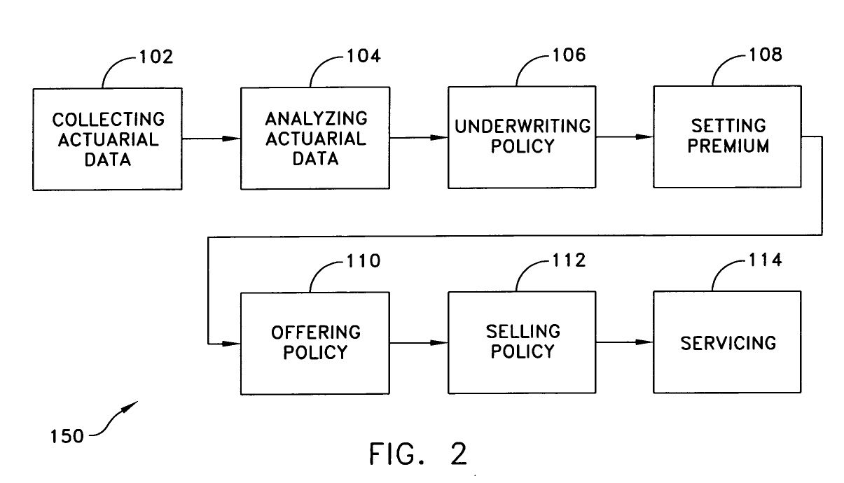

FIG. 2 illustrates an exemplary embodiment of a method 150 of the present invention for generating an insurance policy by: (a) collecting 102 and (b) analyzing actuarial data 104, (c) underwriting 106 the insurance policy for particular buyers and/or sellers of a property; setting a premium 108 for the insurance policy that indemnifies against loses and costs associated with by way of example and not limitation home inspection contract provisions, (c) offering 110 the insurance policy; (d) selling 112 the policy; and (f) servicing 114 claims related to the policy.

System 100 collects information from a real estate inspection population using methods well known by actuaries and statisticians, such as obtained from buyers with contracts for the sale of real estate and contracts for real estate inspections. Each of the contracts for the sale of real estate utilized has an associated contingency term that permits one or more contracting parties to void the contract in the event the inspection is unsatisfactory and/or will not be successfully resolved, either by a remediation of any defects found or an adjustment of the purchase price. Other information collected relates to factors such as market value, sales price, and type of structure, location, best use, age and quality such as workmanship, materials involved in by way of example and not limitation the particular real estate in the population. Since at least part of the decision whether to purchase a property will often depend upon an expert's appraisal of the condition of the property, the system may collect information related to specific inspectors, inspection systems and qualifications of inspectors. The system 100 also collects information related to the cost of by way of example and not limitation the real estate inspections used in the population and the number of contracts for sale voided used in the population. Employing actuarial methods well known to those practicing in the art of actuary the system 100 utilizes the foregoing information to determine the underwriting risk or the cost of providing an insurance policy to insure against the voidance of the contract for sale based upon a contingency related to a defect uncovered during a property inspection.

In one non limiting embodiment of the invention a method for creating the policy and pricing the premium of a specific insurance policy includes receiving data related to a specific inspection contract and sale of property contract and the associated contingency term that permits one or more of the contracting parties to void the contract in the event the inspection is unsatisfactory and/or will not be successfully resolved, either by a remediation of any defects found or an adjustment of the purchase price; information related to factors such as market value, sales price, type of structure, location, best use, age and quality such as workmanship, materials involved in the particular real estate in the population. Since at least part of the decision whether to purchase a property will often depend upon an expert inspector's appraisal of the condition of the property, creation of the insurance policy may use information related to the specific inspector, inspection system utilized and the qualifications of inspector. Having collected sufficient and necessary information the insurance policy creation method then provides the insurance policy to an insured to countervail the financial risk if the real estate transaction is voided because of an unsatisfactory inspection report.

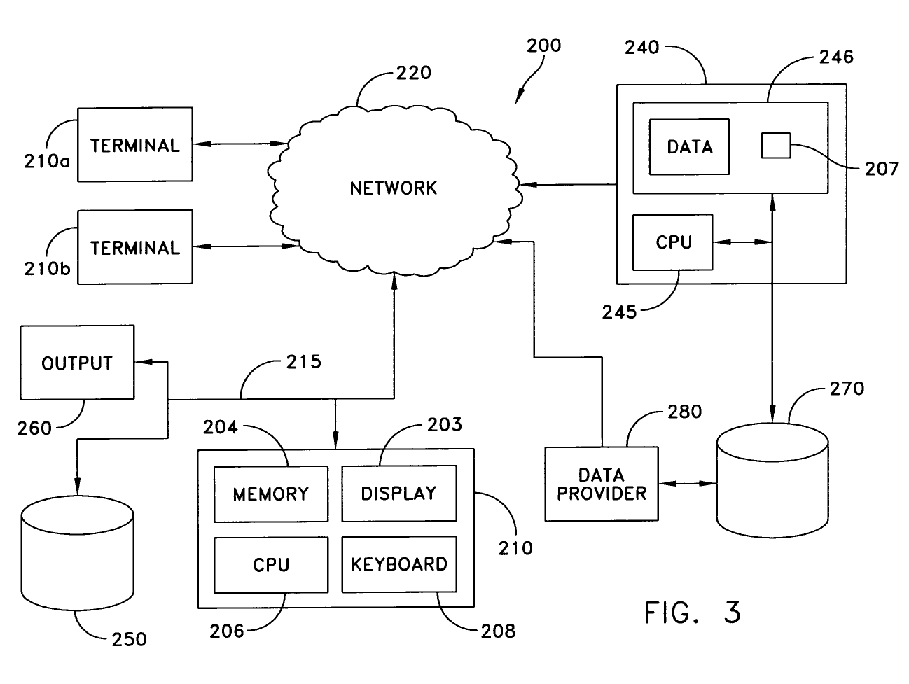

FIG. 3 illustrates one embodiment of the invention wherein a system 200 underwrites, issues and manages a risk insurance policy based upon an inspection report and a contract for the sale of associated real estate by way of example and not limitation having a contingency that permits avoidance of the contract in the event that the inspection uncovers defects in the related property. The system comprises: (a) a computer, such as terminal 210(a-n) including a processor such as a central processing unit (CPU) 206 for processing data; (b) one or more data memories including disks such as ones incorporating database 250 for storing data (1) signifying underwriting risks and corresponding premium rate(s); (2) indicative of the plurality of buyers of sellers of real estate that have or are likely to purchase the risk insurance; (3) indicative of a plurality of inspection contracts and corresponding sales of real estate contracts, each being associated with a corresponding buyer and seller; and/or (4) indicative of contingencies regarding possible voidability or termination of each of the sales contracts. In the exemplary embodiment, the CPU 206 is (1) configured to receive data indicative of the inspection contract and sales contract terms; and (2) configured to prepare an insurance policy utilizing the underwriting risk statistics and corresponding premium rates. The system may also be configured to automatically send, via email or other electronic means, notifications regarding the parties to a real estate transaction having an inspection provision that various options under the sales contract are being exercised, including voidability.

In general, system 200 may also include a network, such as a local area network (LAN) of terminals or workstations, database file servers, input devices (such as keyboards and document scanners) and output devices configured by software (processor executable code), hardware, firmware, and/or combinations thereof, for accumulating, processing, administering and analyzing lease renewal provisions and underwriting insurance in an automated workflow environment. The system provides for off-line and/or on-line quoting, rating, binding, premium billing, notifying and insurance policy generating. This advantageously results in reduced financial risks of inadvertent lease renewal for policy holders. System 200 additionally provides for electronic data transfer pertaining to actuarial data, insurance policy data and billing relating to voidable contracts and related losses.

While a LAN is shown in the illustrated system 200, the invention may be implemented in a system of computer units communicatively coupled to one another over various types of networks, such as a wide area networks and the global interconnection of computers and computer networks commonly referred to as the Internet. Such a network may typically include one or more microprocessor based computing devices, such as computer (PC) workstations, as well as servers. “Computer”, as referred to herein, general refers to a general purpose computing device that includes a processor. “Processor”, as used herein, refers generally to a computing device including a Central Processing Unit (CPU), such as a microprocessor. A CPU generally includes an arithmetic logic unit (ALU), which performs arithmetic and logical operations, and a control unit, which extracts instructions (e.g., software, programs or code) from memory and decodes and executes them, calling on the ALU when necessary. “Memory”, as used herein, refers to one or more devices capable of storing data, such as in the form of chips, tapes, disks or drives. Memory may take the form of one or more media drives, random-access memory (RAM), read-only memory (ROM), programmable read-only memory (PROM), erasable programmable read-only memory (EPROM), or electrically erasable programmable read-only memory (EEPROM) chips, by way of further non-limiting example only. Memory may be internal or external to an integrated unit including a processor. Memory may be internal or external to an integrated unit including a computer.

“Server”, as used herein, generally refers to a computer or device communicatively coupled to a network that manages network resources. For example, a file server is a computer and storage device dedicated to storing files, while a database server is a computer system that processes database queries. A server may refer to a discrete computing device, or may refer to the program that is managing resources rather than an entire computer.

Referring still to FIG. 3, system 200 includes one or more terminals 210a, 210b, . . . ,210n. Each terminal 210 has a processor, such as CPU 206, a display 203 and memory 204. Terminals 210 include code operable by the CPU 206 for quoting, underwriting, rating, binding, billing premiums and generating an insurance policy. Terminals 210 also include code operable to create, sell and manage insurance policies, where the issuance of the policy and the receipt of payment of premiums based upon the insurance policy. A database 250 is interconnected to the terminals 210 for storing predetermined actuarial and rate filings and other data pertinent to an insurance policy generation system. An output device 260, such as a printer or electronic document formatter, such as a portable document format generator, for producing documents, such as hard copy and/or soft copy insurance policies, including at least one of text and graphics, being interconnected and responsive to each of the terminals 210, is also provided. User input device(s) 208 for receiving input into each terminal are also provided.

In one embodiment, output device 260 represents one or more output devices, such as printers, facsimile machines, photocopiers, etc., as for example used to generate hard copy of an insurance policy. Communications lines 215, that may be of wired and/or wireless type, provide interconnectivity between terminals 210, database 250 and one or more networks 220, that may in-turn be communicatively coupled to the Internet, a wide area network, a metropolitan area network, a local area network, a terrestrial broadcast system, a cable network, a satellite network, a wireless network, or a telephone network, as well as portions or combinations of these and other types of networks (all herein referred to variously as a network or the Internet).

In the illustrated embodiment of system 200 other servers 240 having a CPU 245 are in communication with network 220 and terminals 210. As will be recognized by those skilled in the art of networking computers, some or all of the functionality of quoting, underwriting, rating, binding, billing premiums, generating an insurance policy, selling, sending notifications, manage insurance policies, the issuance of the policy and the receipt of payment of premiums may reside on one or more of the terminals 210 or the server 240. Security measures may be used in connection with network transmissions of information, to protect the same from unauthorized access. Such secure networks and methodologies are well known to those skilled in the art of computer and network programming.

In the illustrated embodiment of system 200 server 240 and terminals 210 are communicatively coupled with database 270 to store rate information, information related to underwriting, creating selling and managing insurance policies based upon the underlying provisions in a contract for the sale of real estate. Also available to terminals 210, and stored in databases 250 and 270, are lease data associated with corresponding insurance policies, actuarial tables and premiums associated with various types of lease provision coverages. Database connectivity, such as connectivity with database 270, may be provided by a data provider 280.

In one embodiment, terminals 210 and/or the server 240 utilize computer code, such as code 207 operable and embodied in a computer readable medium 246 in server 240 and code operable and embodied in a computer readable medium 204 in terminal 210, respectively, for mitigating financial loss from risks associated with real estate inspections that reveal a property defect that is uncorrectable, does not result in a financial offset for the defect, or where a party chooses not to correct the defect, one or more causing cancellation of the related sales contract. The computer code provides for establishing at least one database, such as database 250 and/or database 270, for storing the underwriting risks and corresponding premium rates; code for storing data indicative of the plurality of buyers that the have or are likely to purchase insurance in database 250 and/or database 270; code for storing data indicative of a plurality of inspections, each being associated with a corresponding contract for the sale of real estate, in database 250 and/or database 270; code for storing data indicative of time-frames, within which written notice regarding termination of each of the contract for the sale of real estate must be delivered by a party dependently upon the data indicative of the contracts for the sale of the real estate; code for automatically generating at least one electronic (email, fax, Instant Messaging, etc.) notified one or more parties dependently upon the determined time-frames or events leading to a voidance of the sales contract due to a related inspection; code for comparing inspection terms from a prospective applicant for insurance against similar or equivalent terms having associated underwriting risks statistics and corresponding premium rates; and code for utilizing the underwriting risk statistics and corresponding premium rates to prepare insurance policies insuring one or more parties to by way of example and not limitation a real estate transaction having a contingency related to an inspection of the underlying property against losses resulting from a failure to deliver written notice regarding termination of each of the contract for the sale of real estate within the determined time-frames.

In FIG. 3 other hardware configurations may be used in place of, or in combination with software code to implement an embodiment of the invention. For example, the elements illustrated herein may also be implemented as discrete hardware elements. As would be appreciated, terminals 210a, 210b, . . . , 210n and server 240 may be embodied in such means as a general purpose or special purpose computing system, or may be a hardware configuration, such as a dedicated logic circuit, integrated circuit, Programmable Array Logic (PAL), Application Specific Integrated Circuit (ASIC), that provides known outputs in response to known inputs.

FIG. 3 illustrates the operation of a computer-software implemented process 200 for underwriting, quoting, binding, issuing and managing insurance policies related to a voidance of the sales contract due to a related inspection according to an embodiment of the present invention. In an embodiment of the invention, process 200 is carried out by an insurance carrier or underwriter of a indemnity insurance policies dependently upon provisions related to the existence of conditions within an insurable interest, such as real estate or the outlay of money to purchase an inspection service. Software process 200 may be executed using a workstation typical of one or more of the terminals 210, illustrated in FIG. 3. In such an embodiment, system 200 allows users to access process 200 to perform underwriting functions; quote policy coverages and establish premiums for insurance policies in connection with a contingent avoidance of the sales contract.

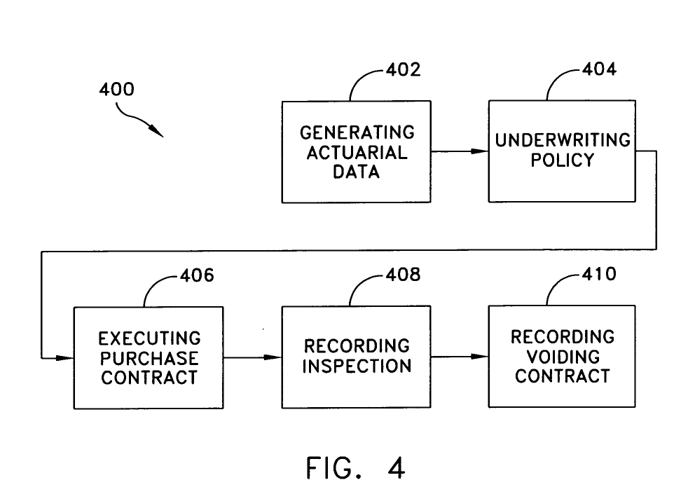

With reference to FIG. 4, a computer method 400 suitable for execution on system 200 for indemnifying against the risk of loss associated with an inspection contingency in a contract for the sale of property comprises the steps of: (a) generating 402 actuarial data from a population of contracts having been voided for failing to meet an inspection contingency; (b) underwriting 404 an insurance policy indemnifying one of a prospective buyer or a seller according to an insurable interest in the property for sale and the actuarial statistics; (c) executing 406 a purchase contract by the buyer and the seller for the property for sale; (d) recording 408 performance of at least one inspection for the insurable interest wherein said inspection reveals the presence of the at least one defect; (e) recording 410 voiding the contract.

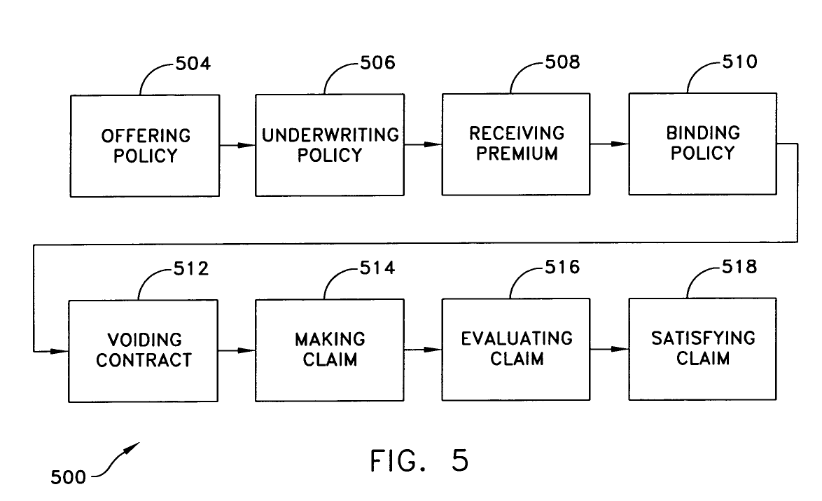

As shown in FIG. 5 one embodiment of the invention is method of providing insurance and a loss payment that includes the steps of: (a) offering 504 the policy to one of the buyer or the seller; (b) underwriting 506 the insurance policy (c) receiving payment 508 premium for the insurance policy; (d) binding 510 the policy for one of the buyer or the seller; (e) voiding 512 a contract for the sale of property based upon information contained in an inspection report; (f) making 514 a claim under the insurance policy; (g) evaluating 516 a claim under the insurance policy using methods well known in by insurance claims adjusters; (h) satisfying 518 a claim on the part of the purchaser of the inspection by paying the amount indicated by the insurance policy. This generally entails paying one of the buyer or the seller for the cost of the inspection and may include the additional. The method of FIG. 5 comprises the additional step (i) of denying a claim under the insurance policy.

In yet a further embodiment of the invention a computer readable medium supports code for mitigating risk associated with property inspections that reveal a defect in a property for sale comprising: (a) code for storing data indicative of a plurality of property sale contracts in the at least one database; (b) code for storing data indicative of the plurality of property inspections in the at least one database; (c) code for storing data indicative of a plurality of insurance policies, each being associated with a corresponding one of the inspections, in the at least one database; (d) code for storing data indicative of one of time-frames or events which require written notice regarding termination of each of the purchase contracts; (e) code for insuring one of the buyer or seller of the property for sale for losses resulting from a failure to close on the property due to a defect in the property revealed during the inspection.

While the foregoing invention has been described with reference to the above embodiments, additional modifications and changes can be made without departing from the spirit of the invention. For example, the indemnification to a buyer or seller may be alternatively or in addition to repayment for inspection fees, indemnification for other fees, costs and expenses associated with the closing (including those paid outside of closing) such as by way of example and not limitation mortgage application fees, property appraisal fees, credit reports and title insurance fees. These typically non-refundable costs paid outside of closing (POC) are generally incurred by the buyer but may be borne by the seller. In accordance with an aspect of the present invention, the insurance policy generated using the method and apparatus of the present invention accounts for the risk associated with the aforementioned typically non-refundable costs, and hence provides the buyer or seller protection with regard to these expense risks. Accordingly, all such modifications and changes are considered to be within the scope of the appended claims.

What is claimed is:

1. A computer method for issuing an insurance policy to indemnify against the cost of purchasing an inspection contract comprising the steps of: identifying a property for sale having an associated risk of a defect; recording a contract for sale having an inspection contingency; generating an insurance policy that accounts for the risk of not satisfying the contingency.

2. A computer method for underwriting insurance for an insurable interest in a property for sale comprising the steps of: (a) generating actuarial statistics from a population of contracts having been voided for failing to meet an inspection contingency; (b) underwriting and (c) binding an insurance policy indemnifying one of a prospective buyer or a seller according to an insurable interest in the property for sale and the actuarial statistics.

3. The method of claim 2, further comprising the steps of: (a) executing a purchase contract by the buyer and the seller for the property for sale; (d) conducting at least one inspection for the insurable interest wherein said inspection reveals the presence of the at least one defect.

4. The method of claim 2, further comprising the step of indemnifying the buyer or seller for the cost of the inspection.

5. The method of claim 2, further comprising paying a premium for the insurance policy.

6. The method of claim 2, further comprising making a claim under the insurance policy.

7. The method of claim 3, further comprising evaluating a claim under the insurance policy.

8. The method of claim 3, further comprising satisfying a claim under the insurance policy.

9. The method of claim 3, further comprising denying a claim under the insurance policy.

10. The method of claim 2, wherein underwriting the insurance policy includes the step of offering the policy to one of the buyer or the seller.

11. The method of claim 2, wherein underwriting the insurance policy includes the step of evaluating applications made by one of a buyer or seller for an insurance policy based on guidelines to determine the risk associated with the insurable interest.

12. A computer method for indemnifying one of a prospective buyer or a seller against losses resulting from a defect in a property for sale comprising the steps of: (a) underwriting an insurance policy that indemnifies against losses sustained by one of a buyer of a buyer in the event of a defect found in the property for sale following an inspection; and (b) recording the voiding of the sale.

13. The method of claim 12, wherein underwriting the insurance policy includes the step of executing a purchase contract by one of the buyer or the seller for the property for sale.

14. The method of claim 12, wherein underwriting the insurance policy includes the step of conducting an inspection of the property for sale, wherein said inspection reveals the presence of the at least one defect.

15. The method of claim 12, wherein underwriting the insurance policy includes the step of executing a contract by one of the buyer or the seller for inspection of the property.

16. A computer method for mitigating risk associated with losses resulting from a defect in a property for sale comprising the steps, comprising:
providing at least one database;
storing data indicative of a plurality of property sale contracts in the at least one database;
storing data indicative of the plurality of property inspections in the at least one database;
storing data indicative of a plurality of insurance policies, each being associated with a corresponding one of the inspections, in the at least one database;
storing data indicative of one of the time-frames or events which require written notice regarding termination of each of the purchase contracts;
storing data indicative of insuring one of the buyer or seller of the property for sale for losses resulting from a failure to close on the property due to a defect in the property revealed during the inspection thus mitigating risk.

17. The method of claim 16, wherein the insured loss includes costs associated with at least one of an inspection that reveals a defect in the property for sale.

18. A computer readable medium for mitigating risk associated with property inspections that reveal a defect in a property for sale, comprising:
code for storing data indicative of a plurality of property sale contracts in the at least one database;
code for storing data indicative of the plurality of property inspections in the at least one database;
code for storing data indicative of a plurality of insurance policies, each being associated with a corresponding one of the inspections, in the at least one database;
code for storing data indicative of one of time-frames or events which require written notice regarding termination of each of the purchase contracts;
code storing data indicative of insuring one of the buyer or seller of the property for sale for losses resulting from a failure to close on the property due to a defect in the property revealed during the inspection.

19. A data processing system for underwriting, issuing and managing an insurance policy to indemnify against losses associated with property inspections comprising:
(a) a CPU for processing insurance policy data related to property inspection insurance; (b) and one or more memories for storing data signifying one or more insurance policies that indemnifies one or more of one of a buyer or a seller against losses sustained in the event of a defect found in the property for sale following an inspection and which defect results in voiding a contract for the sale of the property.

20. The method of claim 2, further comprising the step of indemnifying the buyer or seller for the cost of one or more of mortgage application fees, property appraisal fees, credit reports fees and title insurance fees.
